(19) United States
(12) Patent Application Publication
(10) Pub. No.: US 2005/0207006 A1
(43) Pub. Date: Sep. 22, 2005

(54) Orientation piece

(76) Inventors: Marc Dantin Molina, Overland Park, KS (US); Gary R. Hannah, Shawnee, KS (US); Thomas Kent McDonald, Overland Park, KS (US)

Correspondence Address: Thomas Kent McDonald, 8902 West 97th Street, Overland Park, KS, 66212, US

(21) Appl. No.: 10/805,551

(22) Filed: Mar. 22, 2004

(51) Int. Cl. G02B 17/00

(52) U.S. Cl. 359/399; 359/861

(57) ABSTRACT

An optical orientation piece for use with reflector telescopes for the rotation of the viewed image at the eyepiece to allow for land based viewing. The orientation piece comprises a housing with standard optical interfaces to allow it to be inserted between the telescope focusing mechanism and the eyepiece. The orientation piece design allows it to be rotated about the axis of the telescope drawtube to a point at which the reflected image appears properly oriented to the users real world viewing. The device is capable of rotating the image to any desired angle.

### CROSS REFERENCE TO RELATED APPLICATIONS:

Provisional Patent application Application No. 60/455,481 Mar. 17, 2003 Applicant: Marc Datin Molina United States Patent Documents U.S. Pat. No. 4,600,277 Jul. 15, 1986 Murray, Jr. U.S. Pat. No. 5,144,349 Sep. 1, 1992 Kato et al. U.S. Pat. No. 5,915,136 Jun. 22, 1999 Ruben

### STATEMENT REGARDING FEDERALLY SPONSORED RESEARCH AND DEVELOPMENT - NOT APPLICABLE

### REFERENCE TO SEQUENCE LISTING, A TABLE, OR COMPUTER, PROGRAM LISTING APPENDIX - NOT APPLICABLE

### BACKGROUND OF THE INVENTION

This invention relates to telescope systems. Specifically reflector type telescopes. Reflector telescopes use mirrors to bring an image to a focal point as opposed to lenses found in refractor telescopes. Because a reflector telescope utilizes mirrors vs. lenses to capture the image the resulting image is projected through a focus drawtube located on the side of the telescope as opposed to the back as found on a refractor telescope. The projected image is always inverted 180 degrees and tilted an additional amount based on the angle of the focus drawtube from a vertical plane. While this does not greatly effect astronomical viewing it does prohibit the use of reflector telescopes for land based viewing of objects.

The present invention provides a system of reflecting mirrors and lenses that can be placed between the telescope and the eyepiece and rotated to properly orient the image at any angle necessary to meet the viewers desired perspective.

In other optical devices such as cameras, binoculars, refractor, or spotting scopes it has been shown a similar device known as an inverter. These devices also use a series of lenses and or prisms but are limited in their capabilities to only “invert” or turn the image 180 degrees. They do not have the capability to allow for the rotation of the image at any desired angle.

### BRIEF SUMMARY OF THE INVENTION

In optical devices such as telescopes that employ reflecting mirrors to create a “focal point” the resulting image is often inverted 180 degrees and tilted off center depending on the eyepiece aperture (focus draw tube) location. These types of telescopes are called “Reflector”. This effect is most noticeable in land based versus astronomical viewing of images with these telescopes. Since the radial location of the eyepiece aperture can be moved to suit the viewer's needs a correction device is needed to reverse this effect. The image angle needs to be adjustable to compensate for the angle of “tilt”. Devices to invert the image are available, but no such device is capable of rotating the image to any desired angle, until now. This drawback in reflector telescope design has been accepted because there was no alternative. This is not typically understood by the beginning telescope user and therefore impacts their perception of the product and technology.

The “orientation piece” does this in one unit that fits between the telescope and the focusing eyepiece. The “orientation piece” is a small housing comprising optics and mirrors in a combination that rotates the image to any desired position. It fits into a standard eyepiece receptacle on the telescope or other device and has an output receptacle for the standard eyepiece. Once inserted the “orientation piece” can then be easily rotated until the desired image is correctly oriented and the image “tilt” is eliminated.

### BRIEF DESCRIPTION OF THE DRAWINGS

FIG. 1 A perspective view of the orientation piece

FIG. 2 Orthographic views of the orientation piece.

FIG. 3 An exploded view of the orientation piece

FIG. 4 A functional schematic of a typical reflector telescope design.

FIG. 5 Projected image schematic.

FIG. 6 Reflected light rays on mirrors.

FIG. 7 Image rotation as Orientation Piece rotates

### DETAILED DESCRIPTION OF THE INVENTION

The preferred embodiment of the invention is described in detail with references to drawings.

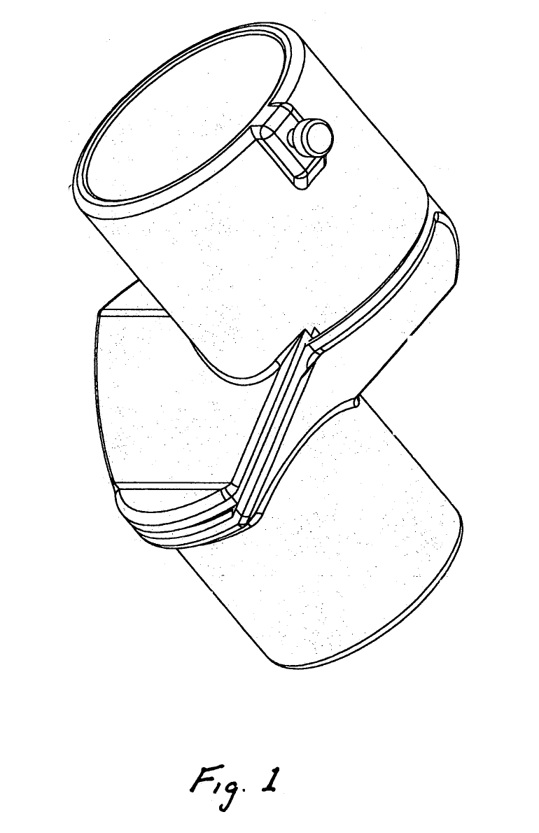

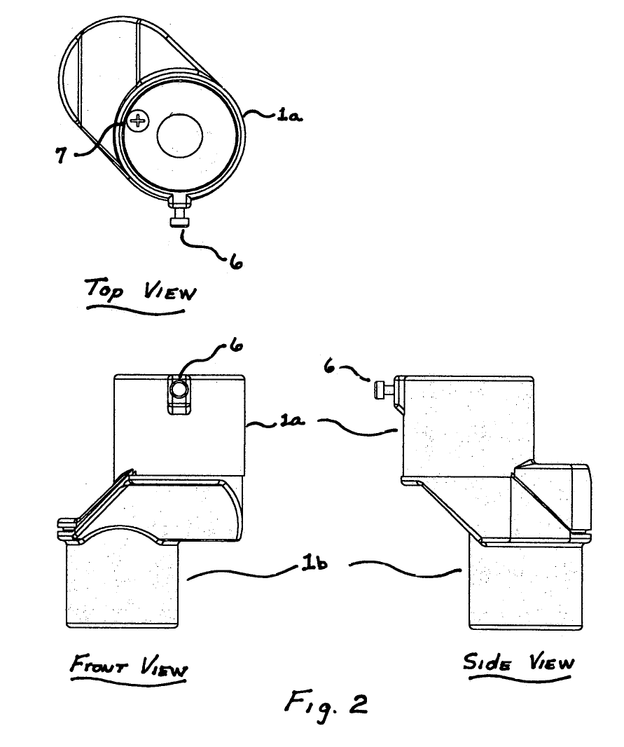

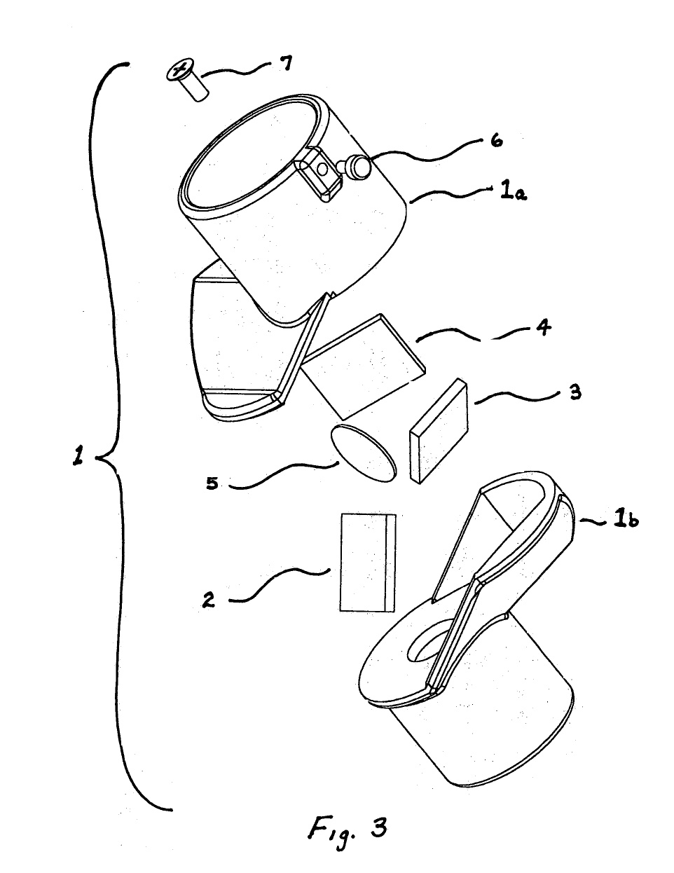

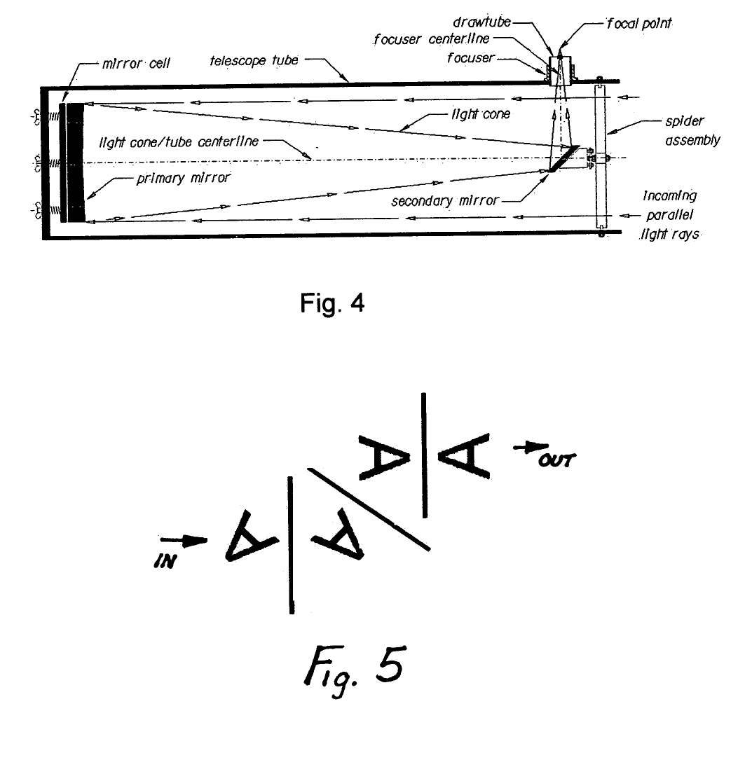

The preferred embodiment of the orientation piece as shown in FIGS. 1, 2, & 3 depicts an offset parallel axis housing consisting of two semi-symmetrical halves. One half an inlet (1b) and the other half an outlet (1a). The said inlet half (1b) dimensionally corresponds to the size standards in diameter for typical telescope eyepieces. This would allow it to be inserted in the focus/drawtube portion of a reflector telescope as shown in FIG. 4. The mating or outlet half (1a) has a dimensionally equivalent outlet to said drawtube designs for mating with a standard optical eyepiece. A thumb screw (6) provides the standard means of retention for the eyepiece. As shown in FIG. 2 and 3 the two halves when assembled retain and position the mirrors (2), (3), and (4).

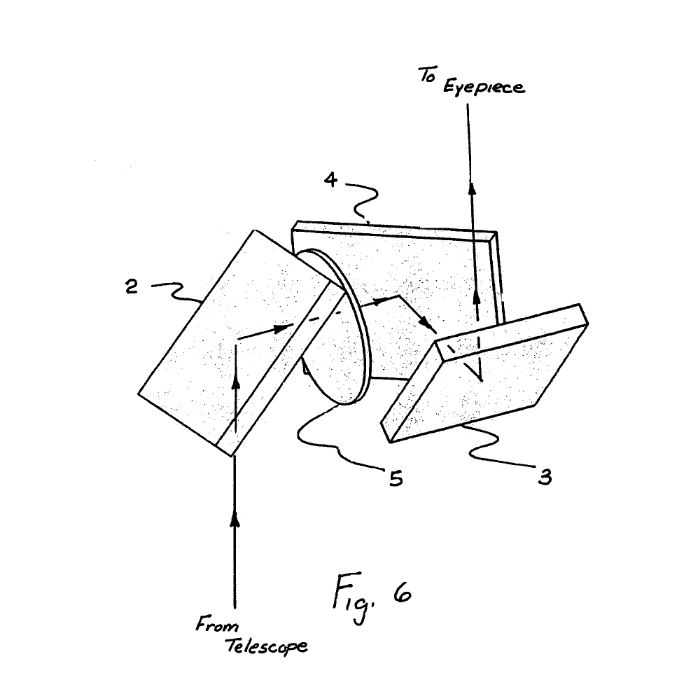

Mirror (2) is placed at 45 degrees to the light (image) path entering the inlet (1b) from the telescope. The received image is reflected to the vertical mirror (4) placed parallel to the axis of the orientation piece and at a 45 degree angle to the surfaces of mirrors (2) & (3). The image is reflected from mirror (4) to mirror (3). Mirror (3) is placed at a 45-degree angle that reflects the image once more and directing it through the outlet (1a) to an eyepiece. (FIG. 5 and 6)

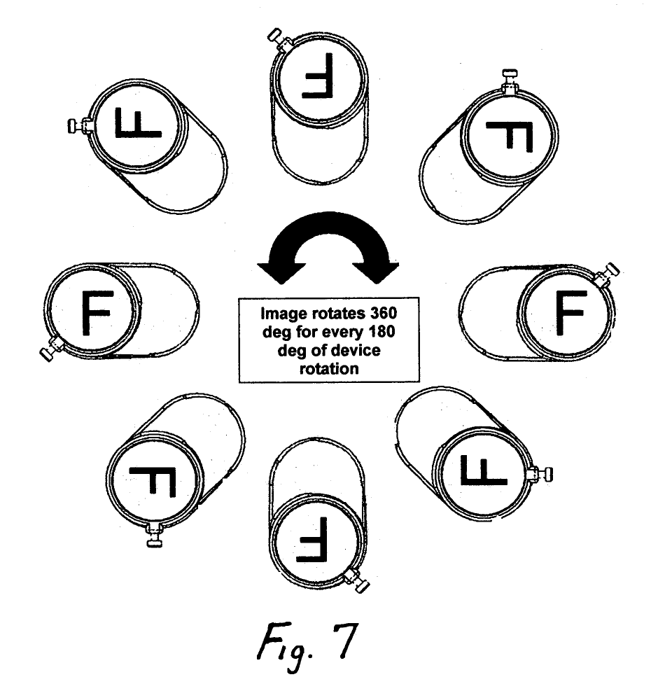

The orientation piece design allows it to be rotated about the axis of the telescope drawtube to a point at which the reflected image appears properly oriented to the users real world viewing. (FIG. 7). The image rotates 360 degrees for every 180 degrees rotation of the orientation piece.

In the second embodiment the orientation piece includes an optical lens, double convex, that is placed between mirrors (2) and (4). The lens is mounted perpendicular to the line of sight or projection. In the first embodiment no allowance is made for the increase in focal distance for the image to be projected. This limits the range of the focuser and choice of eyepiece sizes used. A lens (5) placed as shown in FIG. 3 compensates for additional focal length. The image is projected to the telescope eyepiece at the correct focal angle for viewing per the eyepiece magnification.

A variation of this embodiment is to use a lens that provides other predefined magnification multiplier to the eyepiece used.

A third embodiment would involve the combination of two such devices in series. This combination of 6 reflective surfaces would allow the correction for angular displacement and the correction for any “mirror image” effect.

1. An optical device comprising three to six reflective surfaces for the purpose of rotating the projected image to the eyepiece on a reflector telescope.

2. An optical device comprising three to six reflective surfaces and a lens for the purpose of rotating the image to the eyepiece on a reflector telescope with no change in the image magnification.

3. An optical device as disclosed in claims 1 and 2 that has a lens that increases or decreases the magnification of the rotated image to a predefined power.

4. An optical device as disclosed in claims 1 and 2 that uses prisms with reflective surfaces instead of mirrors to rotate the projected image to the eyepiece on a reflector telescope.
